(19) United States
(12) Patent Application Publication
(10) Pub. No.: US 2013/0264412 A1
(43) Pub. Date: Oct. 10, 2013

(54) ROTARY WING AIRCRAFT HAVING A TAIL ROTOR, AND A METHOD OF OPTIMIZING THE OPERATION OF A TAIL ROTOR

(71) Applicant: EUROCOPTER, (US)

(72) Inventor: Nadine Dyrla, Bouc Bel Air (FR)

(73) Assignee: EUROCOPTER, Marignane (FR)

(21) Appl. No.: 13/765,798

(22) Filed: Feb. 13, 2013

(30) Foreign Application Priority Data
Feb. 21, 2012 (FR) 12 00502

(51) Int. Cl. B64C 27/82

(52) U.S. Cl. CPC B64C 27/82
USPC 244/17.13

(57) ABSTRACT

A rotary wing aircraft (1) provided with a main lift rotor (2), a tail rotor (5), and a power plant (4) driving a main gearbox (3) that co-operates with said main rotor (2), said tail rotor (5) being provided with a plurality of blades (10) of variable pitch (I) and with a pitch modification device (20), and said aircraft (1) having control means (30) for controlling said pitch modification device (20). The aircraft (1) includes an electric motor (9) for rotating said tail rotor (5) and regulator means (TRCU) connected to the control means (30) and also to the electric motor (9) and to the pitch modification device (20). The regulator means (TRCU) generate a first setpoint concerning pitch that is transmitted to the pitch modification device (20), and a second setpoint for controlling a motor parameter that is transmitted to the electric motor (9).

### CROSS REFERENCE TO RELATED APPLICATIONS

This application claims priority to French patent application No. FR 12 00502 filed on Feb. 21, 2012, the disclosure of which is incorporated in its entirety by reference herein.

### BACKGROUND OF THE INVENTION

(1) Field of the Invention

The present invention relates to a rotary wing aircraft provided with a tail rotor, and to a method of optimizing the operation of a tail rotor.

More particularly, the invention lies in the technical field of rotary wing aircraft that include an anti-torque tail rotor. The tail rotor serves to oppose the torque exerted by the main rotor on the fuselage, and it also serves to control the aircraft in yaw.

(2) Description of Related Art

Conventionally, a rotary wing aircraft may have a power plant driving both a main lift rotor and an anti-torque tail rotor in rotation. Such an aircraft may have a mechanical transmission including a main power transmission gearbox (MGB) interposed between the power plant and the main rotor.

The tail rotor may then be connected to the power plant or to the main power transmission gearbox, either directly or via a tail gearbox.

The gearboxes often present a fixed ratio for reducing speed of rotation.

Under such circumstances, the speed of rotation of the main rotor and the speed of rotation of the tail rotor of a rotary wing aircraft are associated by an unchanging ratio that is determined by the mechanical transmission of the aircraft.

In addition, accessories may be connected to the gearboxes of aircraft. These accessories thus give rise to additional constraints.

The main rotor and the tail rotor are consequently not optimized independently of each other. The dimensioning of the main and tail rotors is thus the result of a compromise selected by the manufacturer.

The mechanical transmission may be made so as to enable the main rotor to operate in optimized manner in order to provide the aircraft with lift.

By way of example, the tail rotor is then dimensioned as a function of said mechanical transmission and of a stage of flight that is penalizing. Such a penalizing stage of flight may correspond to hovering flight at a maximum altitude with a maximum side wind and maximum weight.

However, the tail rotor then runs the risk of presenting efficiency that is not optimized during other stages of flight. This situation is particularly constraining when the penalizing stage of flight that was used for dimensioning the tail rotor is likely to arise relatively infrequently in the lifetime of the aircraft.

It is possible to envisage using gearboxes having at least two speed ratios.

Such gearboxes thus give greater freedom to the manufacturer. Nevertheless, it can be understood that the options available for dimensioning remain restricted.

Document U.S. Pat. No. 2,378,617 proposes an aircraft having a main rotor driven by a power plant via a main power transmission gearbox. In addition, the aircraft has a pivoting tail rotor with fixed-pitch blades driven by an electric motor.

A pilot then controls the speed of rotation of the electric motor with first manual means and the position of the tail rotor with the help of second manual means.

Similarly, document US 2010/0123039 proposes an aircraft having a fixed-pitch tail rotor, the tail rotor being driven by an electric motor.

A sensor determines the position of yaw control means. The sensor then communicates with a unit for regulating the electric motor. The regulator unit then determines the speed and the direction of rotation of the electric motor.

Under such circumstances, documents U.S. Pat. No. 2,378,617 and US 2010/0123039 suggest using an electric motor for controlling a fixed-pitch tail rotor.

Thus, the main rotor and the tail rotor of a rotary wing aircraft can be dimensioned independently of each other. Using an electric motor makes it possible to eliminate the dependency relationship between the tail rotor and the main rotor.

Nevertheless, it appears to be difficult to make use of an electric motor.

In order to achieve a setpoint speed greater than a current speed of rotation, the speed of rotation of the electric motor needs to be increased. While the electric motor is accelerating, the speed of rotation of the electric motor then runs the risk of exceeding the setpoint speed before it stabilizes at a value that is substantially equal to the setpoint speed. The person skilled in the art sometimes refers to this phenomenon as “setpoint overshoot”.

This setpoint overshoot phenomenon can also be amplified by aerodynamic phenomena acting on the tail rotor.

This setpoint overshoot phenomenon is sometimes handled using a regulation relationship known by the acronym PID standing for “proportional integral derivative”.

In addition, the assembly comprising the electric motor and the tail rotor can sometimes present non-negligible inertia in rotation. Such inertia can be harmful for countering a sudden violent gust of wind.

Document US 2009/0140095 describes a rotary wing aircraft that operates solely with the help of electric energy.

The aircraft thus has a main rotor driven in rotation by a first electric motor and a tail rotor driven in rotation by a second electric motor.

That aircraft is provided with a control system for controlling the main and tail rotors. The control system appears to include means for controlling the speeds of rotation of the rotors and an autopilot system.

Furthermore, certain aircraft present a ducted tail rotor. Such a ducted tail rotor is advantageous because of its specific features. Nevertheless, a ducted tail rotor and a non-ducted tail rotor are controlled differently.

Under such circumstances, pilots used to flying an aircraft having a non-ducted tail rotor need to adapt their piloting to control an aircraft having a ducted tail rotor. The behavior curve that gives the thrust developed by a tail rotor as a function of the movement of control means is relatively linear with a non-ducted tail rotor, unlike a ducted tail rotor.

The technological background also includes document EP 2 327 625.

### BRIEF SUMMARY OF THE INVENTION

An object of the present invention is thus to propose an aircraft enabling the dimensioning and/or the operation of a tail rotor to be optimized, the tail rotor being capable, for example, of converging rapidly on an operating setpoint.

According to the invention, a rotary wing aircraft has a main lift rotor and a tail rotor, the aircraft also having a power plant driving a main power transmission gearbox (MGB), the main power transmission gearbox driving the main rotor. More particularly, the invention relates to an aircraft having a main rotor driven by a power plant including at least one fuel-burning engine, unlike document US 2009/0140095.

Furthermore, the tail rotor is provided with a plurality of variable-pitch blades and with a pitch modification device, the aircraft having control means for controlling the pitch modification device.

For example, the pitch modification device may include at least one servo-control. The control means may then include either manual means such as pedals, or autopilot type automatic means for generating a pitch variation order, or else a combination of manual means and automatic means for generating an order for varying said pitch.

The aircraft also includes an electric motor for rotating the tail rotor and regulator means that are connected to the control means and also to the electric motor and to the pitch modification device. The regulator means serve to generate a first setpoint relating to pitch that is transmitted to the pitch modification device and also a second setpoint for controlling a motor parameter that is transmitted to the electric motor.

The tail rotor may optionally be driven in one direction only, either clockwise or counterclockwise.

Nevertheless, in a variant, the tail rotor may optionally be capable of being driven in either direction, both clockwise and counterclockwise. The regulator means can then generate a third setpoint specifying the direction of rotation of the tail rotor.

It can be understood that the electric motor may be provided in redundant manner for safety reasons.

The aircraft thus enables the main rotor and the tail rotor to be dimensioned optimally because the aircraft has two distinct drive systems.

The speed of rotation of the main power transmission gearbox determines the speed of rotation of the main rotor. Nevertheless, the operation of the tail rotor is determined at least by an electric motor.

In addition, the aircraft provides great flexibility in use.

The thrust exerted by the tail rotor is not controlled solely by the electric motor, but also by means of the blade pitch of the tail rotor.

It is thus possible to limit or even eliminate the above-mentioned setpoint overshoot phenomenon by controlling both the electric motor and the blade pitch in parallel.

For example, the regulator means may request an increase in the speed of rotation of the electric motor in order to reach a second setpoint, which second setpoint is thus a speed setpoint. It is then possible to modify the pitch of the blades while the speed of rotation of the electric motor is increasing in order to avoid the setpoint overshoot phenomenon.

In addition, the aircraft makes it possible to obtain a response of the tail rotor to an order that may be fast or slow depending on the situation.

The motor parameter to which the second setpoint applies may either be a torque developed by the electric motor or else a speed of rotation of the electric motor.

The torque developed by the electric motor is a function of the magnitude of the electric current passing through it, so a variation in the torque of the electric motor is not inhibited by the rotary inertia of the assembly comprising the electric motor and the tail rotor. It is thus possible to obtain very fast control when using torque servo-control of the electric motor. For example, if the pilot acts quickly on control means in order to counter a gust of wind, that order can give rise to a second setpoint for servo-controlling the electric motor in torque.

Conversely, very slow piloting may be performed using means for servo-controlling the speed of rotation of the electric motor.

The invention also presents a particular advantage for aircraft having ducted tail rotors, since the invention makes it possible to cause the behavior of a ducted tail rotor to tend towards the behavior of a non-ducted tail rotor. By controlling both the electric motor and the blade pitch, it becomes possible to modify the behavior curve for a ducted tail rotor.

In another aspect, the regulator means may apply stored regulation relationships so that the tail rotor is always operated in ranges of use that give rise to optimized energy efficiency.

On a conventional aircraft, the tail rotor operates in an operating range that is determined by the current speed at which the main rotor is being used. However, depending on the stage of flight, the tail rotor and the main rotor may require variations in power that are different or even in opposition in order to ensure that the operation of each of them is optimized.

By dissociating the tail rotor from the main rotor, it becomes possible for each of the rotors to be made to operate in a range that is appropriate therefor.

Under such conditions, the margin for maneuver of the regulator means is increased by virtue of the fact that the regulator means act not only on the electric motor but also on the blade pitch.

Furthermore, the operation of the tail rotor may be hindered by aerodynamic disturbances. Under such circumstances, the regulation relationships of the electric motor may enable the impact of such disturbances to be minimized.

Furthermore, the aircraft may have one or more of the following characteristics.

The aircraft may in particular include an electricity generator connected to said main power transmission gearbox in order to power the electric motor electrically.

Furthermore, the aircraft optionally includes a battery connected to the generator.

The power plant then drives the main power transmission gearbox, which drives the generator. The electrical energy produced by the generator is then transmitted to the electric motor and/or to the battery, if any. The battery may also be used to power the electric motor electrically.

In a first embodiment, the tail rotor may be driven solely with the help of the electric motor.

In a second embodiment, said aircraft includes a differential system mechanically driving said tail rotor, said electric motor co-operating with said differential system, a mechanical transmission connecting said main power transmission gearbox to said differential system.

The tail rotor may then be driven either mechanically via the main power transmission gearbox or electrically via the electric motor, or both mechanically and electrically.

During mechanical drive, the electric motor may optionally operate in generator mode in order to optimize the operation of the tail rotor.

Independently of the embodiment, the electric motor may thus be a combined electric motor and electricity generator.

Furthermore, the aircraft may include means for determining a current stage of flight of the aircraft, these means for determining the stage of flight being connected to the regulator means.

The regulator means then take the stage of flight into consideration in order to cause the tail rotor to operate in an operating range that presents high energy efficiency.

In another aspect, the aircraft may include a system for determining the speed of variation of said pitch required by the control means. The parameter that is controlled by the second setpoint is then optionally selected as a function of the speed of rotation.

In addition to a rotary wing aircraft, the invention also provides a method of optimizing the operation of a tail rotor of an aircraft. The aircraft then has a main lift rotor and a tail rotor, the aircraft having a power plant driving a main power transmission gearbox driving rotation of the main rotor, the tail rotor being provided with a plurality of blades of variable pitch and with a pitch modification device for modifying the pitch of the blades, the aircraft having control means for controlling the pitch modification device.

Furthermore, in this method, an electric motor is provided for rotating the tail rotor and regulator means are provided that are connected to the control means and also to the electric motor and to the pitch modification device, the regulator means implementing stored instructions to generate at least a first setpoint concerning pitch that is transmitted to the pitch modification device and at least a second setpoint for controlling a motor parameter that is transmitted to the electric motor, and optionally at least one third setpoint specifying the direction of rotation of the tail rotor.

The regulator means may thus comprise a calculation unit and a memory, the memory containing instructions that are executed by the calculation unit in order to generate the first setpoint, the second setpoint, and the third setpoint, if any, in order to transmit them to the members concerned.

The way these setpoints are generated makes it possible to optimize the operation of the tail rotor. For example, it becomes possible to make the behavior of a ducted tail rotor tend towards the behavior of a non-ducted tail rotor.

The regulator means may generate at least one setpoint of each type, or indeed a plurality of setpoints of each type.

For example, the regulator means may include anticipation instructions leading to an intermediate first setpoint being calculated followed by a final first setpoint in order to refine the behavior of the tail rotor. This method makes it possible to reach a so-called “final” setpoint by passing via optimized intermediate operating points.

In a variant, the regulator means may include at least one regulation relationship giving the first setpoint and the second setpoint, and optionally a third setpoint, as a function of a thrust setpoint that is to be reached, the thrust setpoint being generated from an order coming from the control means.

Under such conditions, the manufacturer performs testing or calculations in order to draw up an operating curve that gives an optimum pitch and an optimum parameter as a function of a setpoint thrust to be delivered by the tail rotor. On the basis of the setpoint thrust that is to be reached, the regulator means deduce therefrom the setpoints that are to be transmitted by applying instructions that are stored in their memory.

The setpoint thrust may be generated in order to minimize the noise emitted by the tail rotor, in order to optimize fuel consumption, or flight duration, or in order to maximize energy efficiency, for example.

In a variant, the pilot has the option of selecting regulation relationships as a function of an objective the pilot seeks to reach. During a flight over a densely populated area, the pilot may for example select regulation relationships that seek to limit noise emission, whereas in sparsely populated areas the pilot may select regulation relationships that enhance energy efficiency, for example.

In addition, the regulator means may include at least one torque regulation relationship requiring a modification of the torque developed by the electric motor and at least one speed regulation relationship requiring a modification of the speed of rotation of the electric motor.

The regulator means may then implement at least one torque regulation relationship when the control means require a fast variation in the thrust generated by the tail rotor, and at least one speed regulation relationship when the control means require a slow variation of the thrust generated by the tail rotor.

It is considered that said variation is fast when it is above a threshold as determined by the manufacturer, and that it is slow when it is below that threshold.

In a variant, the regulator means identify a current stage of flight of the aircraft from a list of stages of flight as determined by the manufacturer, each predetermined stage of flight being associated with at least one regulation relationship.

Thus, the regulator means optimize the efficiency of the tail rotor by taking the specific features of various stages of flight into consideration.

For example, said regulator means determine the first setpoint and the second setpoint, and possibly a third setpoint by:
determining the current stage of flight;
determining an optimum theoretical thrust associated with the current stage of flight;
determining a setpoint thrust equal to the sum of said theoretical thrust plus a thrust difference required by the control means; and
implementing at least one regulation relationship for deducing the first setpoint, the second setpoint, and the third setpoint, if any, from the setpoint thrust.

### BRIEF DESCRIPTION OF THE SEVERAL VIEWS OF THE DRAWINGS

The invention and its advantages appear in greater detail from the context of the following description of embodiments given by way of illustration and with reference to the accompanying figures, in which:

FIG. 1 shows an aircraft in a first embodiment;

FIG. 2 shows an aircraft in a second embodiment; and

FIG. 3 is a diagram explaining a method.

Elements that are present in more than one of the figures are given the same references in each of them.

### DETAILED DESCRIPTION OF THE INVENTION

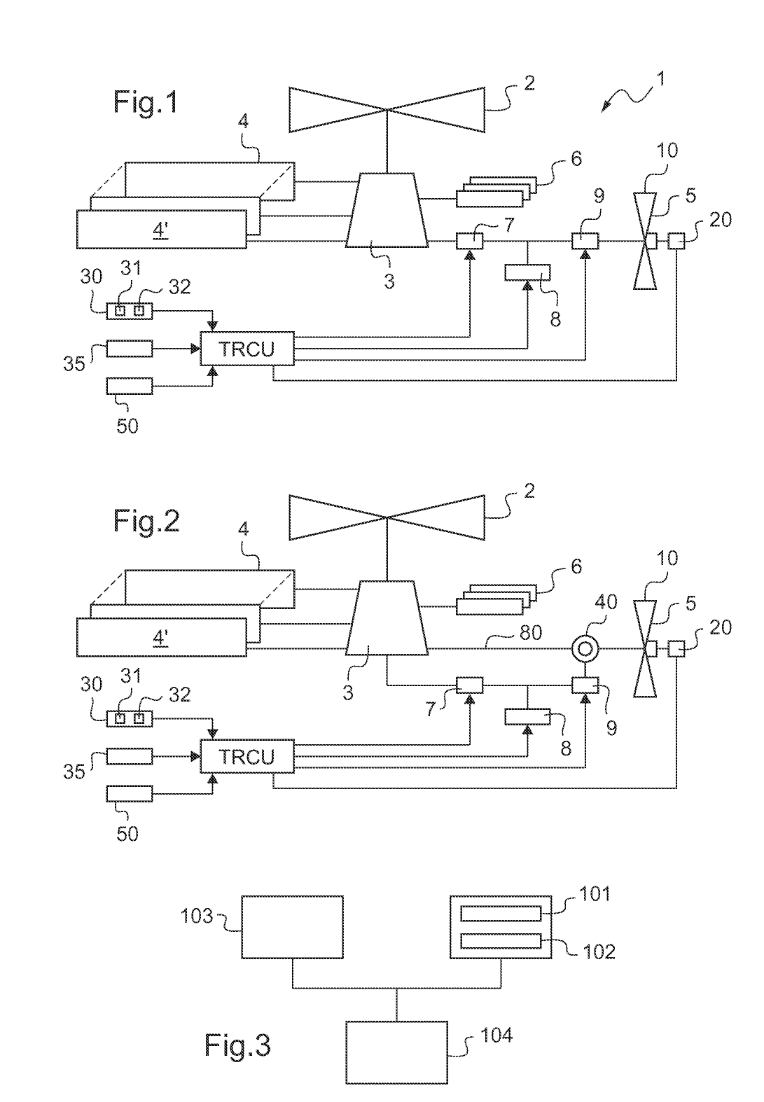

FIG. 1 thus shows a rotary wing aircraft 1 in a first embodiment.

Independently of the embodiment, the aircraft 1 has a power plant 4. This power plant 4 is fitted with at least one engine, and in particular a fuel burning engine 4′.

The power plant 4 then drives a main power transmission gearbox 3. The main power transmission gearbox 3 drives rotation of a main rotor 2 for providing lift and possibility also propulsion, and forming part of the rotary wing of the aircraft. The aircraft 1 may thus of the helicopter type.

The main power transmission gearbox may also drive accessories 6.

Furthermore, the aircraft 1 has an anti-torque tail rotor 5. The tail rotor 5 includes a plurality of blades 10 for opposing the torque generated by the main rotor 2 on the fuselage of the aircraft (not shown).

The pitch I of the blades 10 is variable. Under such circumstances, the aircraft includes a control device 20 for modifying this pitch of the blades 10 in flight on order from control means 30.

Such control means 30 may comprise manual means 31 and/or automatic means 32 for generating a blade pitch variation order. The manual means 31 may for example comprise pedals, and the automatic means may comprise an autopilot system.

In order to enable the tail rotor 5 to be put into rotation independently of the main rotor 2, the aircraft includes an electric motor 9.

The electric motor 9 may be powered by storage means 8, commonly referred to as a “battery”, and/or by an electricity generator 7.

By way of example, the generator 7 is engaged with the main power transmission gearbox 3. The main power transmission gearbox 3 drives the generator 7 so as to produce electricity.

The generator 7 may feed electrical energy directly to the electric motor 9. The generator 7 may also feed electricity to the storage means 8, which storage means are connected to the electric motor 9.

Under such circumstances, the aircraft 1 includes regulator means TRCU. The regulator means TRCU may comprise a calculation unit and a memory, the calculation unit performing instructions stored in the memory.

Thus, the regulator means TRCU include an input connected to the control means 30.

In addition, the regulator means TRCU include outputs for communicating with the pitch modification device 20, the electric motor 9, and optionally the generator 7 and the battery 8 via wired or wireless connections.

Consequently, the control means 30 can send to the regulator means TRCU an order to vary the thrust generated by the tail rotor. It should be observed that automatic control means 32 may be incorporated in the regulator means TRCU.

On the basis of this order and using the instructions stored in its memory, the regulator means establish both a first pitch setpoint that is transmitted to the pitch modification device 20, and also a second setpoint for controlling a motor parameter that is transmitted to the electric motor 9. In addition, the regulator means may optionally establish a third setpoint indicating the direction of rotation for the tail rotor, which third point is also sent to the electric motor.

The second setpoint may be a setpoint concerning the torque to be developed by the electric motor 9, or a setpoint concerning the speed of rotation of the electric motor 9, and thus of the tail rotor 5.

The regulator means may control the regulator 7 and the storage means 8 so as to guarantee that sufficient electrical power is delivered for operating the electric motor 9.

In order to determine the setpoint for transmission, the regulator means TRCU may include at least one regulation relationship for execution.

At least one regulation relationship may give the first setpoint and the second setpoint, and where it exists the third setpoint, as a function of a corresponding setpoint thrust P, the setpoint thrust P being generated on the basis of an order coming from said control means 30.

The manufacturer may establish a set of curves in a chart plotting the pitch I for the blades of the tail rotor along the abscissa axis and plotting the setpoint thrust P that is to be given up the ordinate axis. Each curve in the set corresponds to a speed of rotation of the electric motor and of thus of the tail rotor 5.

From this set of curves, the manufacturer can establish an optimum operating curve that satisfies given objectives, such as minimizing the noise generated by the tail rotor 5 or indeed maximizing the efficiency of the tail rotor 5.

On the basis of a setpoint thrust derived from a thrust variation order given by the control means, it is possible from this operating curve to deduce the setpoints that are to be transmitted.

In order to optimize the operation of the aircraft, and in particular of the tail rotor 5, at least two regulation relationships may be envisaged.

By way of example, the regulator means may have at least one regulation relationship per motor parameter, i.e.: at least one torque regulation relationship requesting a modification of the torque developed by the electric motor; and a speed regulation relationship requesting a modification of the speed of rotation of the electric motor.

As a function of the pitch variation speed requested by the control means, the regulator means may give precedence to using a torque regulation relationship or a speed regulation relationship.

The aircraft may include a system 35 for determining the speed with which said pitch requested by the control means is to vary. This speed-determination system 35 may be of conventional type and communicate with the regulator means TRCU.

In addition, the current state of flight may also be taken into account.

The aircraft 1 then has means 50 for determining a current stage of flight of the aircraft 1, these stage-of-flight determination means 50 being connected to the regulator means TRCU. For example, it is possible to determine the stage of flight with the help of the forward speed of the aircraft and its altitude.

The regulator means then uses regulation relationships that are associated with the current stage of flight.

With reference to FIG. 3 and in order to determine the setpoint thrust, the regulator means may identify the current stage of flight during a step 101.

With the help of information stored in its memory, the regulator means act during a step 102 to determine a theoretically optimum thrust associated with the stage of flight, and corresponding to a non-zero yaw angle in a side wind, for example. This theoretical thrust may be generated so as to minimize the noise delivered by the tail rotor, so as to optimize fuel consumption, so as to optimize flight duration, or indeed so as to maximize energy efficiency, for example.

In parallel, and during a step 103, the regulator means determine the thrust difference required by the control means.

The setpoint thrust is then equal to the sum of the theoretical thrust plus the required thrust difference.

On the basis of this setpoint thrust, and during a step 104, the regulator means establish setpoints for transmitting to the electric motor 9 and to the pitch modification device 20.

In the first embodiment of FIG. 1, the aircraft is capable of driving the tail rotor 5 only with the help of the electric motor.

In the second embodiment, a differential system 40 is arranged between the electric motor 9 and the tail rotor 5.

A mechanical transmission 80 is then arranged in parallel with the electric motor 9 between the differential system 40 and the main power transmission gearbox 3.

The tail rotor may thus be driven mechanically by the main power transmission gearbox 3 and/or electrically by the electric motor 9.

Naturally, the present invention may be subjected to numerous variations as to its implementation. Although several embodiments are described above, it will readily be understood that it is not conceivable to identify exhaustively all possible embodiments. It is naturally possible to envisage replacing any of the means described by equivalent means without going beyond the ambit of the present invention.

What is claimed is:

1. A rotary wing aircraft having a main lift rotor and a tail rotor, said aircraft having a power plant with at least one fuel-burning engine driving a main power transmission gearbox, said main power transmission gearbox driving said main rotor, said tail rotor being provided with a plurality of blades of variable pitch (I) and with a pitch modification device, said aircraft having control means for controlling said pitch modification device, and said aircraft including regulator means (TRCU) and an electric motor for rotating said tail rotor, the regulator means (TRCU) being connected to the control means and also to the electric motor and to the pitch modification device in order to generate a first setpoint for pitch that is transmitted to the pitch modification device and a second setpoint for controlling a motor parameter that is transmitted to the electric motor.

2. An aircraft according to claim 1, wherein said control means include either manual means, or automatic means for generating an order for varying said pitch, or both manual means and automatic means for generating an order for varying said pitch.

3. An aircraft according to claim 1, wherein said aircraft includes an electricity generator connected to said main power transmission gearbox in order to power said electric motor electrically.

4. An aircraft according to claim 3, wherein said aircraft includes a battery connected to said generator.

5. An aircraft according to claim 1, wherein said aircraft includes a differential system mechanically driving said tail rotor, said electric motor co-operating with said differential system, a mechanical transmission connecting said main power transmission gearbox to said differential system.

6. An aircraft according to claim 1, wherein said electric motor is a combined electric motor and electricity generator.

7. An aircraft according to claim 1, wherein said aircraft includes means for determining a current stage of flight of the aircraft, said means for determining the stage of flight being connected to the regulator means (TRCU).

8. An aircraft according to claim 1, wherein said motor parameter is either a torque of said electric motor or a speed of rotation of the electric motor.

9. An aircraft according to claim 1, wherein said aircraft includes a system for determining the speed of variation of said pitch required by the control means.

10. A method of optimizing the operation of a tail rotor of a rotary wing aircraft also having a main lift rotor, said aircraft having a power plant driving a main power transmission gearbox driving rotation of said main rotor, said tail rotor being provided with a plurality of blades of variable pitch (I) and with a pitch modification device for modifying the pitch of the blades, said aircraft having control means for controlling said pitch modification device, wherein an electric motor is provided for rotating said tail rotor and regulator means (TRCU) are provided that are connected to the control means and also to the electric motor and to the pitch modification device, the regulator means (TRCU) implementing stored instructions to generate at least a first setpoint concerning pitch that is transmitted to the pitch modification device and at least a second setpoint for controlling a motor parameter that is transmitted to the electric motor.

11. A method according to claim 10, wherein said regulator means (TRCU) execute at least one regulation relationship giving the first setpoint and the second setpoint as a function of a thrust setpoint (P) that is to be reached, said thrust setpoint (P) being generated from an order coming from said control means.

12. A method according to claim 10, wherein said regulator means (TRCU) execute at least one torque regulation relationship requiring a modification of the torque developed by the electric motor and at least one speed regulation relationship requiring a modification of the speed of rotation of the electric motor.

13. A method according to claim 10, wherein said regulator means (TRCU) implement at least one torque regulation relationship when the control means require a fast variation in the thrust generated by the tail rotor, and at least one speed regulation relationship when the control means require a slow variation of the thrust generated by the tail rotor.

14. A method according to claim 10, wherein said regulator means (TRCU) identify a current stage of flight of the aircraft from a list of stages of flight as predetermined by the manufacturer, each predetermined stage of flight being associated with at least one regulation relationship.

15. A method according to claim 10, wherein said regulator means determine the first setpoint and the second setpoint by:
determining the current stage of flight;
determining an optimum theoretical thrust associated with the current stage of flight;
determining a setpoint thrust equal to the sum of said theoretical thrust plus a thrust difference required by the control means; and
implementing at least one regulation relationship for deducing the first setpoint and the second setpoint from the setpoint thrust.
